(19) United States
(12) Patent Application Publication
(10) Pub. No.: US 2026/0253920 A1
(43) Pub. Date: Aug. 27, 2026

(54) SEALING DEVICE FOR AT LEAST ONE FUEL CELL STACK

(71) Applicant: AVL List GmbH, Graz (AT)

(72) Inventors: Vincent LAWLOR, Stainz (AT); Christoph SCHLUCKNER, Graz (AT); Robert PÖSCHL, Gratwein-Straßenengel (AT)

(73) Assignee: AVL List GmbH, Graz (AT)

(21) Appl. No.: 18/856,652

(22) PCT Filed: Apr. 13, 2023
(86) PCT No.: PCT/AT2023/060125

§ 371 Date: Oct. 14, 2024

(30) Foreign Application Priority Data
Apr. 14, 2022 (AT) A 50248/2022

(51) Int. Cl. H01M 8/0276; H01M 8/12; H01M 8/2432; H01M 8/2475; H01M 8/2483; H01M 8/249

(52) U.S. Cl. CPC H01M 8/0276; H01M 8/12; H01M 8/2432; H01M 8/2475; H01M 8/2483; H01M 8/249; H01M 2008/1293

(57) ABSTRACT

The invention relates to a sealing device (1) for at least one fuel cell stack (2), in particular an SOFC fuel cell stack, comprising a housing (3) and at least one fuel cell stack (2) which is arranged or arrangeable within the housing (3), wherein the at least one fuel cell stack (2) comprises a plurality of fuel cells (4), wherein the fuel cells (4) each have at least one further seal (5) at their lateral ends, wherein the housing (3) surrounds the at least one fuel cell stack (3) with the further seal (5), wherein at least one sealing element (6) is arranged between the housing (3) and the further seal (5) for pressure equalisation.

The invention also relates to a fuel cell system, in particular an SOFC fuel cell system, with such a sealing device (1).

The invention relates to a sealing device for at least one fuel cell stack, in particular an SOFC fuel cell stack, comprising a housing and at least one fuel cell stack which is arranged or arrangeable within the housing, wherein the at least one fuel cell stack comprises several fuel cells, wherein the fuel cells have at least one further seal at their lateral ends, wherein the housing surrounds the at least one fuel cell stack with the further seal.

It is known from the prior art for individual elements of fuel cells (anode, cathode, bipolar plate) within the fuel cell stack to be internally sealed against each other. This is carried out with a further seal, which is usually made of a glass. However, it is quite possible that, during the operation of SOFC fuel cell systems in particular, this glass seal begins to melt or liquefy, also in a fuel cell stack of said fuel cell system, due to the high temperatures. If the pressure differences between the fuel cell stack and the environment are too great, it can be the case that the glass seal is pressed outwards. This should be avoided at all costs, since this can damage or even destroy the fuel cell stack.

This is the starting point for the invention. The object of the invention is to provide a sealing device which solves the aforementioned problems, in particular reduces pressure differences.

A further object is to specify a use of such a fuel cell system.

According to the invention, the object is achieved in that, in a sealing device of the type mentioned above, at least one sealing element is arranged between the housing and the further seal for pressure equalisation.

One advantage achieved through the design of the sealing device according to the invention is to be seen in particular in the fact that the housing in particular is no longer directly connected to the further seal; rather, the sealing element is arranged between the housing and the further seal. The sealing element can thus be regarded as a buffer device and/or pressure equalisation element.

The sealing device encloses at least one, preferably several, for example forty fuel cell stacks, whereby the housing is preferably arranged around all the fuel cell stacks, i.e. a common housing for all fuel cell stacks is formed and provided. The housing seals the fuel cell stack from the environment outside of the fuel cell stack in a gas-tight manner, but usually not in a pressure-tight manner. In sealing devices and/or fuel cell stacks according to the prior art, the ambient pressure thus then acts on the fuel cell stack and in particular on the at least one further seal. Due to the sealing element according to the invention, the housing is arranged at a distance from the fuel cell stack and the further seal. In a vertical direction, the sealing element is preferably arranged between an inlet side and an outlet side, but in each case to the side of the fuel cell stack. Since the fuel cells are sealed at both ends over an entire height of the fuel cell stack with the further seal, at least one sealing element is also arranged between the housing and the fuel cell stack on both sides of the fuel cell stack.

In the context of the invention, the sealing device according to the invention is not only to be understood as the seal itself but, as described, as a sealing device enclosing at least one fuel cell stack. In order to achieve pressure equalisation, the described seal can be used advantageously for fuel cell stacks of any design and arrangement, in particular SOFC fuel cell stacks. In the context of the invention, it is in particular not necessary for the sealing element of the sealing device to be one hundred percent tight. This can for example also, advantageously, be partially permeable to gas in order to achieve pressure equalisation. The sealing element according to the invention is in particular to a large extent tight.

Preferably, the at least one fuel cell stack is designed with an open cathode, which means that a single air flow is conducted over the entire fuel cell stack(s). The housing limits the air flow to the outside. According to the invention, part of this air flow is also conducted outside of the fuel cell stack itself at least up to the sealing element. For example, the sealing element can advantageously be arranged, in a top view, approximately in the middle of the further seal. This makes it possible for the air flow to flow outside of the fuel cell stack both on the inlet side and on the outlet side. Consequently, it is no longer the ambient pressure that acts on the further sealing element, but the pressure of the air flow. A pressure difference is therefore reduced and the further sealing element(s) remain in their intended place even at a high temperature. The distance between the housing and the fuel cell stack, which substantially corresponds to a thickness of the sealing element, should advantageously not exceed a defined width, so that a large part of the quantity of air in the air flow flows inside the fuel cell stack and not outside it. The fuel cell stack(s) are in particular flowed through horizontally by an air stream, whereby an anode flow is substantially oriented roughly orthogonally thereto.

One or more fuel cell stacks are arranged within the housing, whereby a manifold is arranged, in particular on their underside at their or vertically lowest point, for the supply of anode supply gas or fuel. Building on these manifolds, there are several, for example 50 individual fuel cells which are preferably flat in form and stacked on top of each other to form a fuel cell stack. The fuel cell stacks are preferably designed with an open cathode, whereby the air flow within the housing is conducted over all fuel cell stacks. This is preferably directed laterally onto the fuel cell stacks in such a way that the air is conducted between (and also to the side of) the ends of the fuel cells which include the additional seal. Anode supply gas is fed to the underside of the fuel cell stack, flows substantially vertically upwards through this and is then conducted back down to the manifold, where the anode supply gas usually exits the manifold again.

It is advantageous if the sealing element is gas-tight or slightly porous. If the sealing element is slightly porous, a small part of the air can flow through it, so that a pressure gradient is formed between an inlet side and an outlet side of the fuel cell stack, since the sealing element is slightly untight. This pressure gradient outside of the fuel cell stack (but inside the housing) corresponds substantially to the pressure gradient inside the fuel cell stack. If, on the other hand, the sealing element is gas-tight, the pressure of the outlet side of the fuel cell stack prevails above the sealing element and the pressure of the inlet side of the fuel cell stack below it. The sealing element can preferably be made of an aluminium silicate or sealing compounds or swelling material (swell mat) or similar materials.

It is advantageous if the sealing element extends either over an entire side of the at least one fuel cell stack or only over a part thereof. In a first possible variant, the sealing element advantageously extends over the entire depth and/or height of a fuel cell stack, which is in this case advantageously porous, so that a pressure equalisation can take place between a fuel cell inlet side and a fuel cell outlet side. In another possible variant, the sealing element only extends over a part of a height of the fuel cell stack, whereby this can advantageously be arranged approximately in the middle of a height and/or a depth of the fuel cell stack. However, this can also be arranged at a lower or upper end of the fuel cell system, for example. In this variant, the sealing element can be advantageously be gas-tight or somewhat gas-permeable. In principle, it can also be advantageous if two or more sealing elements are arranged on each side of the fuel cell stack, these being arranged at a predetermined distance from each other.

It is expedient if several fuel cell stacks are arranged within the housing, whereby each fuel cell stack has at least one further seal and a sealing element is in each case arranged between the further seal of two fuel cell stacks. The individual fuel cell stacks are advantageously both stacked on top of each other as well as arranged next to each other, so that a kind of wall or array is formed. When arranged side by side, each fuel cell stack has at least one further seal of its own on each side thereof. A sealing element for both fuel cell stacks is advantageously provided between two fuel cell stacks which always separates two fuel cell stacks. As described above, two or more sealing elements can also be arranged vertically on top of each other between two fuel cell stacks. If two or more fuel cell stacks are arranged on top of each other, each fuel cell stack has its own manifold for supplying anode supply gas. The sealing element can for example also be formed over an entire height of all fuel cell stacks. In such an arrangement of several fuel cell stacks, these in turn are advantageously designed with an open cathode, so that an air flow can flow to and through these together. The fuel cell stacks are surrounded by a common housing.

It is advantageous if the sealing element has a capillary element or can be bypassed by a capillary element. If the sealing element is designed to be gas-tight, a capillary element can be advantageous for the defined passage of air, so that air can also flow outside of the fuel cell stack from a fuel cell inlet to a fuel cell outlet. The capillary element is in particular designed as a pressure-communicating tube. The capillary element can either pass directly through the sealing element or can be designed as a kind of bypass which runs around the housing and bypasses the sealing element. The capillary element is for example formed of a steel or a corresponding alloy.

It is favourable if one, two, three or more sealing elements are arranged between the further seal and the housing and/or between the further seal of a first fuel cell stack and the further seal of a further fuel cell stack. The sealing elements are arranged vertically on top of each other and spaced apart from each other on each side of a fuel cell stack. An arrangement of two or more sealing elements allows an air flow outside of the fuel cell stack to be controlled even more effectively.

When manufacturing the sealing device, it can be advantageous if the sealing element is pressed onto the further seal of the fuel cell stack. The advantage here is that it is not absolutely necessary for the sealing element to be gas-tight with the further seal.

Alternatively, the object is also achieved according to the invention in that, in a sealing device of the aforementioned type, a predetermined air gap is arranged between the housing and the further seal for pressure equalisation.

One advantage achieved in this way can also be seen, in particular, in the fact that the housing is no longer directly connected to the further seal; instead, the air gap is arranged between the housing and the further seal. The air gap can thus be seen as a buffer device, whereby the housing is no longer directly connected to the fuel cell stack. This represents an alternative to the sealing element which has substantially the same advantages as described in detail above.

In both versions, sealing element and air gap, it is advantageous if the housing is indirectly connected to the further seal. On both sides of the fuel cell stack, at least one further seal is provided which is not directly connected to the housing, since either at least one sealing element or an air gap is provided on both sides of the fuel cell stack, so that a pressure equalisation can take place between an inlet and an outlet of the fuel cell stack.

The sealing device with at least one fuel cell stack according to the invention is advantageously used in an SOFC fuel cell system, which is preferably designed or used as a stationary installation. A corresponding SOFC fuel cell system advantageously includes further elements such as a reformer, an afterburner, several heat exchangers, optionally a recirculation section as well as several pipes, valves and the like. If several fuel cell stacks are provided, it is advantageous if these are arranged in a kind of matrix, whereby those fuel cell stacks that are stacked on top of each other in a column are electrically connected to each other. The fuel cell stacks which are arranged next to each other should be electrically isolated from each other. The sealing element or the air gap itself can advantageously be used for this purpose and a ceramic insulation can for example be dispensed with.

Further advantages, features and details of the invention are explained in the following description, in which exemplary embodiments of the invention are described in detail with reference to the drawing. In each case schematically:

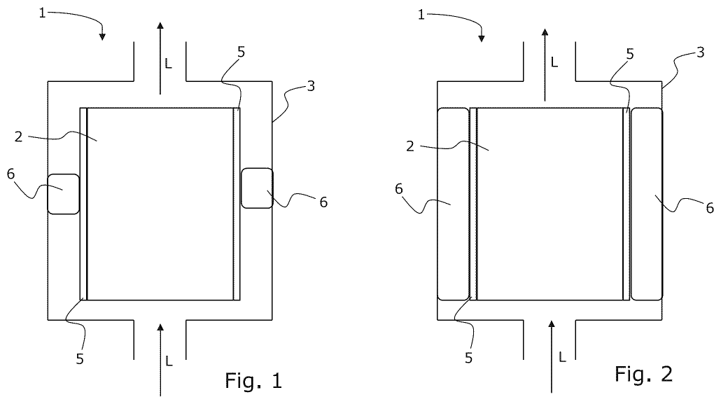

FIG. 1 shows a schematic representation of a top view of a sealing device according to the invention;

FIG. 2 shows a schematic representation of a top view of a further sealing device according to the invention;

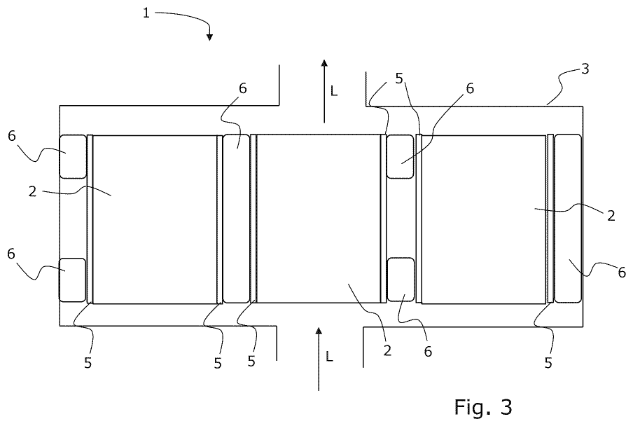

FIG. 3 shows a schematic representation of a top view of a further sealing device according to the invention;

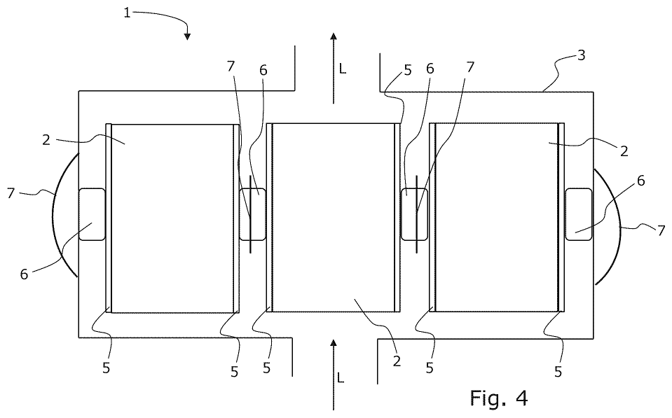

FIG. 4 shows a schematic representation of a top view of a further sealing device according to the invention;

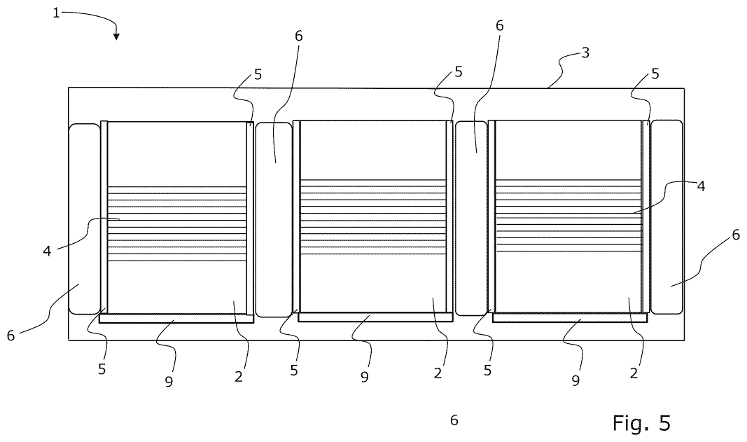

FIG. 5 shows a schematic representation of a section through a further sealing device according to the invention;

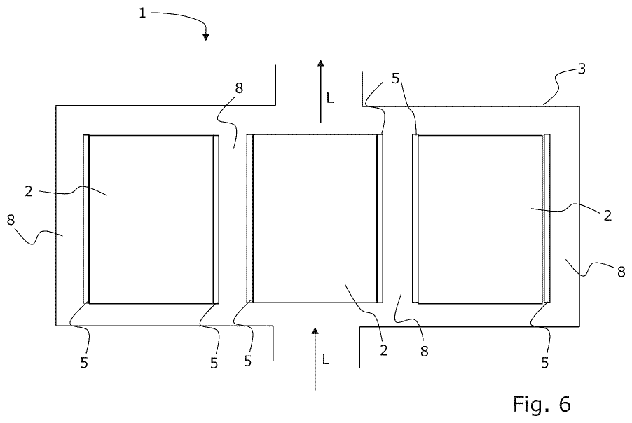

FIG. 6 shows a schematic representation of a top view of a further sealing device according to the invention.

FIG. 1 shows a top view of a sealing device 1 according to the invention with a fuel cell stack 2. The fuel cell stack 2 comprises several fuel cells 4, which are not marked in FIG. 1. Since this figure represents a top view, exactly one fuel cell 4 is visible from above, since the rest are stacked underneath it. The fuel cell stack 2 is arranged within a housing 3. The individual fuel cells 4 are electrically sealed at their two lateral ends with a further seal 5 between the individual elements of the fuel cells 4. The further seal 5 is made of glass and extends over the entire height and preferably depth of the fuel cell stack 2. The fuel cell stack 2 is designed with an open cathode, so that an air flow L can be conducted over the entire surface of the fuel cell stack 2. A sealing element 6 is arranged on both sides of the fuel cell stack 2 between the housing 3 and the fuel cell stack 2 or the further seal 5. According to FIG. 1, this is located about halfway down the fuel cell stack 2 and is gas-tight or porous. Due to the sealing element 6, the housing 3 is arranged at a distance from the fuel cell stack 2, so that the air flow L does not pass completely through the fuel cell stack 2, a part of it also passes by to the right and left thereof. This ensures that the pressure outside of the fuel cell stack 2 is substantially the same as that in the fuel cell stack 2. Since the air can flow at least as far as the sealing element 6, even with an outlet of the fuel cell stack 2, it is guaranteed that the further seal 5 does not have to withstand the pressure outside of the housing 3. If the sealing element 6 is porous, this means that a certain amount of air can also penetrate through the sealing element 6.

All figures which show a top view of the sealing device 1 according to the invention are flowed through by the air flow L in the direction of a depth of the fuel cell stack 2, whereby the further seals 5 are arranged laterally on the fuel cell stacks 2. An anode supply gas or fuel is substantially conducted from bottom to top within the fuel cell stack, whereby an outlet for the fuel can again be arranged on an underside, and the individual fuel cells 4 can of course also be supplied with fuel horizontally.

For better understanding, the distance between the housing 3 and the further seal 5 is shown quite large in all the figures, and the sealing element 6 is shown quite large. It goes without saying that this distance should be so small that the greater part of the air flows through the fuel cell stack 2 itself, with only a predetermined proportion flowing past to the right and left of it.

FIG. 2 shows a top view of a further sealing device 1 according to the invention. Elements which have the same function and in particular the same arrangement as those shown in FIG. 1 also have the same reference signs and are not described further. In contrast to FIG. 1, in the sealing device 1 according to FIG. 2 the sealing elements 6 are the same height as the fuel cell stack 2 or extend over the entire height and depth of the fuel cell stack 2 and the further seals 5. The sealing elements 6 are porous, so that a predetermined proportion of air can pass through these and a pressure gradient between the housing 3 and the further seal 5 corresponds substantially to that within fuel cell stack 2.

FIG. 3 shows a top view of a further sealing device 1 according to the invention. Elements which have the same function and in particular the same arrangement as those shown in FIG. 1 and/or FIG. 2 also have the same reference signs and are not described further. This is a view in which three fuel cell stack 2 are arranged next to each other. Several fuel cell stacks 2 can also be arranged on top of each other. It can be seen that a sealing element 6 is provided not only between fuel cell stack 2 with further seal 5 and housing 3, but also between two respective fuel cell stacks 2. One sealing element 6 is sufficient for two fuel cell stacks 2. A further advantage of such an arrangement is that the sealing element 6 also eliminates the need for a separate horizontal electrical protection between the individual fuel cell stack 2. The sealing element 6 itself also forms an electrical seal. Vertically, the individual fuel cell stacks 2 are to be electrically connected to each other. The housing 3 contains all the fuel cell stacks 2, and the air flow L impinges on and flows through all the fuel cell stacks at the same time. FIG. 3 shows two different possibilities for the arrangement and formation of the sealing elements 6: in each case two sealing elements 6 are arranged between two fuel cell stacks 2 and two sealing elements 6 on the one hand and between a fuel cell stack 2 and the housing 3 on the other, whereby these are arranged at the two lateral ends of the fuel cells 2. The other two sealing elements 6 shown extend over an entire depth of the fuel cell stack 2. It goes without saying that the arrangements and designs of the sealing elements 6 are only shown here by way of example. Any number of these can be provided and combined. These can be different, as shown here, or all sealing elements 6 per sealing device 1 can be designed in the same way.

FIG. 4 shows a top view of a further sealing device 1 according to the invention. Elements which have the same function and in particular the same arrangement as those shown in FIG. 1 and/or FIG. 2 and/or FIG. 3 also have the same reference signs and are not described further. This sealing device 1 again encloses several fuel cell stacks 2, whereby the sealing elements 6 are arranged approximately in the middle of the fuel cell stack 2 and do not extend over its entire depth. In this sealing device 1, capillary elements 7 are provided which are either passed through the gas-tight sealing element 6 (see sealing elements 6 between two fuel cell stacks 2) or form a pressure-communicating bypass around the sealing element 6 (see sealing elements 6 between fuel cell stack 2 and housing 3). The capillary elements 7 are substantially tubes that are designed in such a way that a pressure on an inlet side is substantially equal to that on an outlet side of the fuel cell stack 2. It goes without saying that the arrangements of the capillary elements 7 are shown here purely by way of example. Either all of these can pass through the sealing elements 6 or all of these can be designed as a bypass or combined as desired.

FIG. 5 shows a top view of a sealing device 1 according to the invention with several fuel cell stacks 2. Elements which have the same function and in particular the same arrangement as those shown in FIG. 1 and/or FIG. 2 and/or FIG. 3 and/or FIG. 4 also have the same reference signs and are not described further. In this view, the individual fuel cells 4 are represented schematically, whereby it is understood that these usually extend over the entire width of the fuel cell stack 2. Simply for clarity of representation, not all fuel cells 4 are drawn in. In this representation, the air flow L would lead into the plane of the drawing. A manifold 9 for supplying anode supply gas or fuel can be seen here on the underside of the fuel cell stack 2. The sealing device 1 according to the invention can also advantageously enclose one or more vertical rows of fuel cell stacks 2 with the elements as shown in FIG. 5, whereby the individual rows are then stacked on top of each other and are all arranged within a common housing 3. Each fuel cell stack 2 has its own manifold 9, but the air flow L passes through all fuel cell stacks 2 together, since they are designed with an open cathode.

FIG. 6 shows a second variant of the sealing device 1 according to the invention. This does not include a sealing element 6; instead, an air gap 8 is provided to create a pressure equalisation between a fuel cell inlet and a fuel cell outlet. Here too, the air flow L not only passes through the respective fuel cell stack 2, air is also passed between the fuel cell stacks 2 and between the fuel cell stack 2 and the housing 3. In FIG. 6 too, the respective air gap 8 is always represented oversized. Elements which have the same function and in particular the same arrangement as those shown in FIG. 1 and/or FIG. 2 and/or FIG. 3 and/or FIG. 4 and/or FIG. 5 also have the same reference signs and are not described further.

1. Sealing device for at least one fuel cell stack, in particular an SOFC fuel cell stack, comprising a housing and at least one fuel cell stack which is arranged or arrangeable within the housing, wherein the at least one fuel cell stack comprises a plurality of fuel cells, wherein the fuel cells each have at least one further seal at their lateral ends, wherein the housing surrounds the at least one fuel cell stack with the further seal, characterised in that at least one sealing element is arranged between the housing and the further seal for pressure equalisation.

2. Sealing device according to claim 1, wherein the sealing element is gas-tight or slightly porous.

3. Sealing device according to claim 1, wherein that the sealing element extends either over an entire side of the at least one fuel cell stack or only over a part thereof.

4. Sealing device according to claim 1, wherein a plurality of fuel cell stacks are arranged within the housing, wherein each fuel cell stack has at least one further seal and a sealing element is in each case arranged between the further seal of two fuel cell stacks.

5. Sealing device according to claim 1, wherein the sealing element has a capillary element or can be bypassed by a capillary element.

6. Sealing device according to claim 1, wherein one, two, three or more sealing elements are arranged between the further seal and the housing and/or between the further seal of a first fuel cell stack and the further seal (5) of a further fuel cell stack.

7. Sealing device for at least one fuel cell stack, in particular an SOFC fuel cell stack, comprising a housing and at least one fuel cell stack which is arranged or arrangeable within the housing, wherein the at least one fuel cell stack comprises a plurality of fuel cells, wherein the fuel cells each have at least one further seal at their lateral ends, wherein the housing surrounds the at least one fuel cell stack with the further seal, wherein a predetermined air gap is arranged between the housing and the further seal for pressure equalisation.

8. Sealing device according to claim 1, wherein the housing is indirectly connected to the further seal.

9. Fuel cell system, in particular an SOFC fuel cell system, comprising a sealing device according to claim 1 with a plurality of fuel cell stacks.
